(19) United States
(12) Patent Application Publication
(10) Pub. No.: US 2025/0026204 A1
(43) Pub. Date: Jan. 23, 2025

(54) TWO-SERIES SPRING DAMPING TYPE CURRENT COLLECTOR FOR SUBWAY VEHICLES

(71) Applicant: BEIJING JIAOTONG UNIVERSITY, Beijing (CN)

(72) Inventors: Yongjun LIU, Beijing (CN); Xingzhi YANG, Beijing (CN); Dekun XIONG, Beijing (CN); Jinchao LIU, Beijing (CN); Yezheng LI, Beijing (CN)

(73) Assignee: BEIJING JIAOTONG UNIVERSITY, Beijing (CN)

(21) Appl. No.: 18/772,923

(22) Filed: Jul. 15, 2024

(30) Foreign Application Priority Data
Jul. 20, 2023 (CN) 202310894311.6

(51) Int. Cl. B60L 5/39

(52) U.S. Cl. CPC B60L 5/39

(57) ABSTRACT

Provided is a two-series spring damping type current collector for subway vehicles including an insulating back plate connected to one side of each of second tooth-shaped plates through a corresponding one of first tooth-shaped plates arranged at two lateral portions of the insulating back plate, and an other side of the second tooth-shaped plates is connected to a mounting plate. One end of the tension steel spring is connected to a first spring connecting piece, an other end of the tension steel spring is connected to a second spring connecting piece, the tension steel spring is internally provided with the rubber block in a shape of cylinder, a diameter of the rubber block is equal to that of an inner cavity of the tension steel spring, a length of the rubber block is equal to that of the tension steel spring in a pre-tightened state.

### CROSS-REFERENCE TO RELATED APPLICATION

This patent application claims the benefit and priority of Chinese Patent Application No. 202310894311.6 filed with the China National Intellectual Property Administration on Jul. 20, 2023, the disclosure of which is incorporated by reference herein in its entirety as part of the present application.

### TECHNICAL FIELD

The present disclosure relates to a two-series spring damping type current collector for subway vehicles, and belongs to the technical field of rail transit vehicles.

### BACKGROUND

A third-rail current collector is a device mounted on the bogie of subway vehicles and is in contact with a third rail through a collector shoe to obtain electric energy. The third-rail current collector is in an upper current collection form when the collector shoe is in contact with an upper surface of the third rail, while the third-rail current collector is in a lower current collection form when the collector shoe is in contact with a lower surface of the third rail.

Currently, the force between the current collector and the third rail is provided by the pre-tightening of a steel spring. During operation, the lack of damping results in loosening of bolts connecting sliders, and fatigue fracture of the swing arm. Various manners of the pre-tightening by the steel spring causes fatigue of the spring and contact force with large fluctuation. And the instable contact also causes arc discharge, resulting in the born of the slider of the collector shoe and the third rail, which intensifies wear and tear between the slider and the third rail, causes an instable current between the collector shoe and the third rail, and gives rise to the economic loss and the safety problem.

Parameters of the spring used for pre-tightening, such as a structure and a type, affect running stability and safety of the current collector.

Steel springs used by current collectors mainly include tension springs and torsion springs. A tension spring is a spring using tension to work. A torsion spring is a spring using torque to work. In contrast, the tension spring has good stability and long service life and the torsion spring is prone to fatigue failure and has short service life.

There are two methods for mounting the springs: dual spring symmetrically mounting or single spring mounting. The dual spring symmetrically mounting means two same springs are symmetrically mounted on the current collector, and the two springs bear a load simultaneously. The single spring mounting means only one spring is mounted on the middle or one side of the current collector.

### SUMMARY

To overcome shortcomings in the prior art, the present disclosure provides a two-series spring damping type current collector for subway vehicles.

A two-series spring damping type current collector for subway vehicles is provided. The two-series spring damping type current collector for subway vehicles includes an insulating back plate, wherein the insulating back plate is connected to one side of each of second tooth-shaped plates through a corresponding one of first tooth-shaped plates arranged at two lateral portions of the insulating back plate, and an other side of the each of the second tooth-shaped plates is connected to a mounting plate;

a first spring assembly arranged on one side of the mounting plate, wherein the spring assembly includes a rubber block and a tension steel spring, one end of the tension steel spring is connected to a first spring connecting piece, an other end of the tension steel spring is connected to a second spring connecting piece. The tension steel spring is internally provided with the rubber block in a shape of cylinder, a diameter of the rubber block is equal to a diameter of an inner cavity of the tension steel spring, a length of the rubber block is equal to a length of the tension steel spring in a pre-tightened state. The first spring connecting piece is connected to a first spring adjustable connecting block through a first shaft, the first spring adjustable connecting block is connected to one end of a first bolt, an other end of the first bolt is connected to the mounting plate through a first rubber gasket and a first screw cap. The second spring connecting piece is connected to a second spring adjustable connecting block through a second shaft, the second spring adjustable connecting block is connected to one end of a second bolt, and an other end of the second bolt is connected to a swing arm through a second rubber gasket and a second screw cap; and

a swing arm assembly including the swing arm, a slider mounting seat and a collector shoe, wherein one end of the swing arm is connected to the mounting seat and the collector shoe, and an other end of the swing arm is connected to a second fixed block connected to a limit block; a stopper is connected to the mounting plate; a first fixed block is connected to the mounting plate. The first fixed block and the second fixed block are rotationally connected by a main shaft.

A limit mounting seat is connected to the mounting plate; a limit switch is connected to the limit mounting seat; the limit switch is connected to a limit shaft; a lower part of the limit switch is connected to a limit switch stopper; and a stop block is connected to the swing arm.

A second spring assembly is arranged on an other side of the mounting plate, wherein the second spring assembly is a same as the first spring assembly. The swing arm is capable of performing an arc movement along an end face of the first fixed block. The limit block is capable of being in contact with the stopper. The limit switch stopper is capable of being in contact with the stop block. An upward swing limit of the swing arm is determined by contact of the limit block with the stopper; and a downward swing limit of the swing arm is determined by contact of the limit switch stopper with the stop block.

The present disclosure has the advantages that: technical problems caused by the manner of the pre-tightening of the single stage spring that easy fatigue of the spring, contact force with large fluctuation, an instable current collection state are solved; the structure is simple, and the mounting is convenient; the tension steel spring with a built-in rubber block is connected to the swing arm assembly to provide bidirectional damping, so that fluctuations of the contact force between the collector shoe and the third rail are more stable, and the stability and safety of current collection are ensured.

The swing arm assembly designed in the present disclosure includes the swing arm, the slider mounting seat, the collector shoe, the fixed blocks, and the spring adjustable connecting blocks. One end of the swing arm is connected to the slider mounting seat. The slider mounting seat is provided with the collector shoe. The fixed blocks and the spring adjustable connecting blocks are arranged at the other end of the swing arm. The swing arm is made of a carbon fiber reinforced resin based composite material, which has good insulating performance, further isolates current, so as to solves a problem of frequent current leakage caused by insufficient insulating performance of a back plate of a traditional current collector, ensuring safe driving of a vehicle, reducing faults, improving use safety of the current collector, prolonging stable service life, and reducing the maintenance cost.

According to the present disclosure, rubber gaskets are respectively arranged between the spring adjustable connecting block and the mounting plate and between the spring adjustable connecting block and the swing arm to adjust the pre-tightening force of the spring according to use conditions. When the vehicle vibrates, the rubber gaskets achieve an effect of buffering, an acting force of the spring assembly on the mounting plate and the swing arm is reduced, so that the stability and safety of a current collection structure are ensured, contact force fluctuations between the slider of the current collector and the third rail are more stable, and the stability and safety of current collection are ensured.

The spring assembly designed by the present disclosure includes the tension steel spring and the rubber block. The rubber block is placed in the tension steel spring which achieves an effect of buffering when the tension steel spring is compressed, and does not work when the tension steel spring is stretched. A buffering effect of the rubber block reduces acting forces of the spring on the connecting blocks, the mounting plate, and the swing arm, and meanwhile, can reduce the impact of a high-frequency vibration generated during running of the vehicle on the current collector, prolong the service life of the tension steel spring, reduce the fatigue of the tension steel spring, and ensure the use safety of the current collector.

The spring assembly designed in the present disclosure includes the tension steel spring and the rubber block. The rubber block achieves effects of buffering and damping. The two-series spring damping can be achieved during working of the spring assemblies. Compared with a traditional single stage pre-tightened current collector, a phenomenon that a contact surface is burnt due to arc discharge will not occur, pre-tightening force fluctuations are smaller, the current collection is more stable, the service life of the tension steel spring is prolonged, and the safety performance of the tension steel spring is improved.

The spring structure of the present disclosure is a tension steel spring structure that two springs are symmetrically mounted. Compared with a traditional single stage spring structure, when a two-series spring structure is supplied, a force applied on the spring is more stable and smaller, and the service life of the spring is prolonged.

Compared with a traditional torsion spring, the tension steel spring has longer service life, is not prone to fatigue, does not need to be replaced frequently, and reduces the maintenance cost. Since the tension steel spring can only provide a unidirectional tension, the rubber block mounted can bear a pressure when the spring is compressed, which achieves an effect of buffering, protects the stability of the spring structure and the current collector during running, and achieves effects of buffering and damping when the tension steel spring is compressed.

### BRIEF DESCRIPTION OF THE DRAWINGS

When considering in combination with accompanying drawings, the present disclosure can be more completely and better understood and many accompanying advantages in the present disclosure are easily obtained with reference to the following detailed descriptions. However, the accompanying drawings described herein are used for providing a further understanding of the present disclosure, and constitute a part of the present disclosure. Exemplary embodiments of the present disclosure and descriptions thereof are used for explaining the present disclosure, but do not constitute improper limitations to the present disclosure. As shown in the drawings:

FIG. 1 is a three-dimensional structural schematic diagram of a two-series spring damping type current collector for subway vehicles of the present disclosure;

FIG. 2 is a front view of the two-series spring damping type current collector for subway vehicles of the present disclosure;

FIG. 3 is a bottom view of the two-series spring damping type current collector for subway vehicles of the present disclosure;

FIG. 4 is a structural schematic diagram of a spring assembly of the present disclosure; and

FIG. 5 is a sectional view of the spring assembly of the present disclosure.

### DETAILED DESCRIPTION OF THE EMBODIMENTS

The present disclosure is further described below with reference to accompanying drawings and embodiments.

Apparently, many modifications and changes made by those skilled in the art based on a purpose of the present disclosure fall within the scope of protection of the present disclosure.

Those skilled in the art may understand that, unless specifically stated, singular forms such as “a”, “one”, “the” and “this” used herein may also include plural forms. It is further to be understood that, a term “including” used in the specification of the present disclosure refers to the existence of features, integers, steps, operations, elements, and/or components, but does not exclude the existence or addition of one or more other features, integers, steps, operations, elements, components, and/or groups of them. It is to be understood that when an element or a component is “connected” to another element or component, it may be directly connected to another element or component, or there may also be an intermediate element or component. A term “and/or” used here includes any unit and all combinations of one or more associated listed items.

Those skilled in the art may understand that, unless otherwise defined, all terms including technical terms and scientific terms used herein have the same meanings as those commonly understood by those of ordinary skill in the art.

To facilitate understanding of the embodiments, further explanation and description will be made in combination with the accompanying drawings. Various embodiments do not constitute a limitation to the present disclosure.

### Embodiment 1

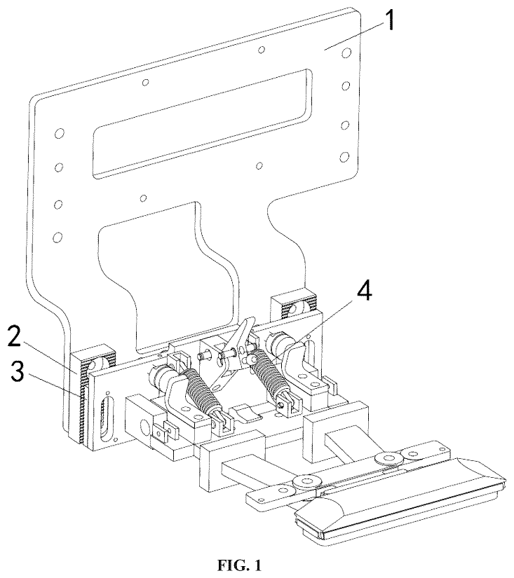

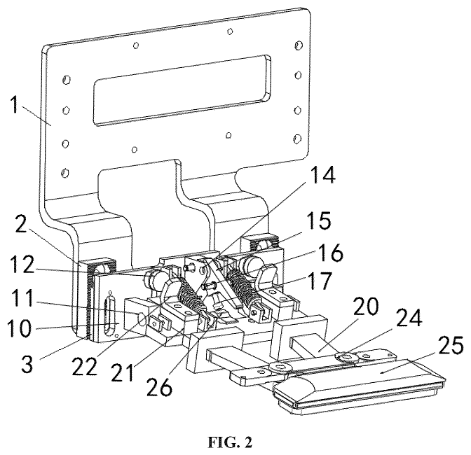

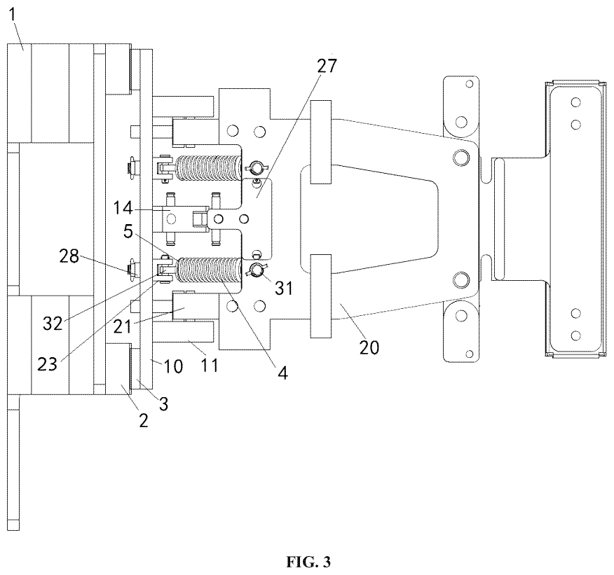

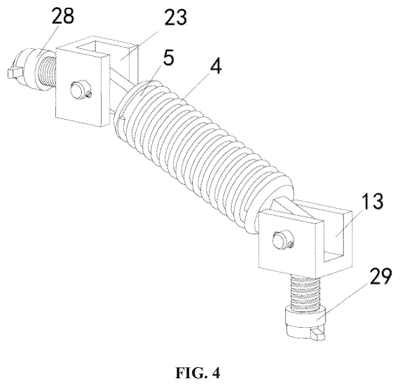

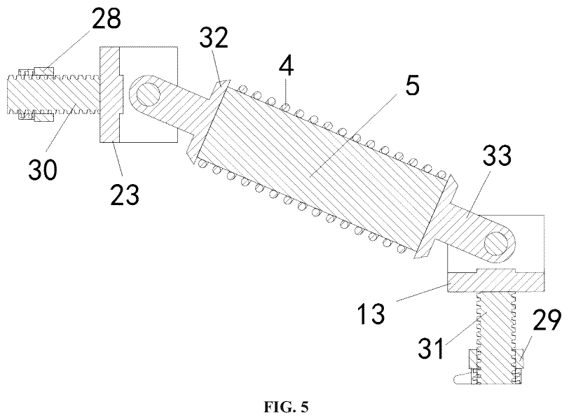

As shown in FIG. 1, FIG. 2, FIG. 3, FIG. 4, and FIG. 5, a two-series spring damping type current collector for subway vehicles includes an insulating back plate 1, two spring assemblies and a swing arm assembly. The insulating back plate 1 is connected to one side of each of second tooth-shaped plates 3 through a corresponding one of first tooth-shaped plates 2 arranged at two lateral portions of the insulating back plate, and the other side of each of the second tooth-shaped plates 3 is connected to a mounting plate 10.

One of the spring assemblies is arranged on one side of the mounting plate 10, the spring assembly includes a rubber block 5 and a tension steel spring 4. One end of the tension steel spring 4 is connected to a first spring connecting piece 32, the other end of the tension steel spring 4 is connected to a second spring connecting piece 33. The tension steel spring 4 is internally provide with the cylindrical rubber block 5, wherein the diameter of the rubber block 5 is equal to that of the inner cavity of the tension steel spring 4, and the length of the rubber block 5 is equal to that of the tension steel spring 4 in the pre-tightened state. The first spring connecting piece 32 is connected to a first spring adjustable connecting block 23 through a first shaft, the first spring adjustable connecting block 23 is connected to one end of a first bolt 30, the other end of the first bolt 30 is connected to the mounting plate 10 through a first rubber gasket 28 and a first screw cap. The second spring connecting piece 33 is connected to a second spring adjustable connecting block 13 through a second shaft, the second spring adjustable connecting block 13 is connected to one end of a second bolt 31, and the other end of the second bolt 31 is connected to a swing arm 20 through a second rubber gasket 29 and a second screw cap.

The other one of the spring assemblies which is identical to the one of the spring assemblies is arranged on the other side of the mounting plate 10.

The swing arm assembly includes a swing arm 20, a slider mounting seat 24 and a collector shoe 25. One end of the swing arm 20 is connected to the slider mounting seat 24 and the collector shoe 25, and the other end of the swing arm 20 is connected to a second fixed block 21 connected to a limit block 22, the limit block 22 can be in contact with a stopper 12 connected to the mounting plate 10, a first fixed block 11 is connected to the mounting plate 10 and the swing arm 20 can perform an arc movement along an end surface of the first fixed block 11.

A limit mounting seat 14 is connected to the mounting plate 10. A limit switch 15 is connected to the limit mounting seat 14. The limit switch 15 is connected to a limit shaft 16. A lower part of the limit switch 15 is connected to a limit switch stopper 17. A stop block 26 is connected to the swing arm 20. The limit switch stopper 17 can be in contact with the stop block 26.

An upward swing limit of the swing arm 20 is determined by contact of the limit block 22 with the stopper 12. A downward swing limit of the swing arm 20 is determined by contact of the limit switch stopper 17 with the stop block 26.

### Embodiment 2

As shown in FIG. 1, FIG. 2, FIG. 3, FIG. 4, and FIG. 5, a two-series spring damping type current collector for subway vehicles includes an insulating back plate 1, a swing arm assembly and spring assemblies. One side of the insulating back plate 1 is detachably connected to first tooth-shaped plates 2, a mounting plate 10 is fixedly connected to the first tooth-shaped plates 2, tooth surfaces of the first tooth-shaped plates 2 and second tooth-shaped plates 3 are engaged to connect the insulating back plate 1 to the mounting plate 10; the mounting plate 10 is rotatably connected to a swing arm assembly through a spring assembly and a main shaft rotationally connecting a first fixed block and a second fixed block; and a collector shoe 25 that is in contact with a third rail is mounted to one end of a swing arm assembly.

The swing arm assembly is provided with a swing arm 20, a slider mounting seat 24, the collector shoe 25, a second fixed block 21, and a first spring adjustable connecting block 23. The second fixed block 21 is rotationally connected to the first fixed block 11 through the main shaft so that the swing arm assembly can rotate around the first fixed block 11. The second fixed block 21 is fixedly connected to a limit block 22. The limit block 22 can be in contact with a stopper 12 on the mounting plate 10 to limit a swing limit of the swing arm assembly.

The first spring adjustable connecting block 23 is connected to the mounting plate 10 through the first bolt. A second spring adjustable connecting block 13 is connected to the swing arm assembly. The swing arm assembly is tightly attached to the third rail by a pressure provided by the spring assembly.

A first rubber gasket 28 is arranged between the first spring adjustable connecting block 23 and the mounting plate 10. A second rubber gasket 29 between the second spring adjustable connecting block 13 and the swing arm 20. When the spring assembly works, a function of buffering acting forces between the first spring adjustable connecting block 23 and the mounting plate 10 and between the swing arm 20 and the second spring adjustable connecting block 13 can be realized.

The spring assembly includes a tension steel spring 4 and a rubber block 5. The tension steel spring 4 is connected to the first spring adjustable connecting block 23 through a first spring connecting piece 32. The rubber block 5 is placed within the tension steel spring 4, which achieves a function of buffering when the tension steel spring is compressed, and does not work when the tension steel spring is stretched. A limit mounting seat 14 is arranged in the middle of the mounting plate 10. A limit switch 15 is arranged on the limit mounting seat 14. A limit shaft 16 and a limit switch stopper 17 act to limit a s wing amplitude of the swing arm assembly.

The first tooth-shaped plates 2 and the second tooth-shaped plates 3 fit to each other through teeth thereof, so that a relative position between the mounting plate 10 and the insulating back plate 1 can be adjusted, and thus the current collector of the present disclosure is adapted to contact between various vehicles and the third rail.

On the basis of the first rubber gasket 28 arranged between the first spring adjustable connecting block 23 and the mounting plate 10 and the second rubber gasket 29 arranged between the second spring adjustable connecting block 13 and the swing arm 20, when the tension steel spring 4 works, the rubber block 5 may buffer a force of the tension steel spring 4 on the second spring adjustable connecting block 13 and the swing arm 20 and a force of the tension steel spring 4 on the first spring adjustable connecting block 23 and the mounting plate 10. When a vehicle vibrates, the rubber block 5 may also achieve an effect of buffering to ensure running stability of the current collector, so that the structure of the current collector is stable.

Compared a traditional torsion spring, the tension steel spring 4 has better stress and is not prone to fatigue. The rubber block 5 arranged in the tension steel spring achieves an effect of buffering when the tension steel spring is compressed, and does not work when the tension steel spring is stretched, so that the service life of the tension steel spring is prolonged, the fatigue of the tension steel spring is reduced, and thus the maintenance cost is reduced.

The swing arm 20 of the swing arm assembly is made of a carbon fiber reinforced resin based composite material that is sturdy and durable to prolongs the service life of the current collector, reduces the maintenance cost of the current collector, and has good insulating performance to further isolates current, prevents a phenomenon of current leakage of the current collector and ensures the running safety of a vehicle. The design of the spring assembly with the tension steel spring 4 and the rubber block 5 achieves stable and smooth contact between the current collector and the third rail, improves the running safety of the vehicle, and facilitates later testing and maintenance.

The collector shoe 25 in contact with the third rail is arranged at one end of the swing arm assembly. The spring assemblies are symmetrically mounted on two sides. One end of the spring assembly is mounted on the swing arm assembly, and the other end of the spring assembly is mounted on the mounting plate 10. The tension steel spring 4 is connected to the swing arm assembly through the second spring adjustable connecting block 13, so that the tension steel spring 4 can rotate with rotation of the swing arm assembly. The tension steel spring 4 is connected to the mounting plate 10 through the first spring adjustable connecting block 23, so that the tightness of the tension steel spring can be adjusted at any time.

The swing arm assembly includes the slider mounting seat 24 and the collector shoe 25. One end of the swing arm 20 is provided with the collector shoe 25 that is in contact with the third rail, and the other end, away from the collector shoe 25, of the swing arm 20 is provided with the second fixed block 21 and the second spring adjustable connecting block 13.

Two end of the mounting plate 10 are provided with first fixed blocks 11, each of which is connected to the second fixed block 21 through a main shaft.

The second fixed block 21 is connected to the limit block 22 through a bolt. The limit block 22 and the stopper 12 on the mounting plate 10 works together to limit the swing amplitude of the swing arm assembly.

The limit switch 15 arranged in the middle of the mounting plate 10 can limit the swing amplitude of the swing arm assembly.

One side of the mounting plate 10 is connected with the second tooth-shaped plates 3 by bolts. The mounting plate 10 is connected to the insulating back plate 1 through the first tooth-shaped plates 2 and the second tooth-shaped plates 3.

The limit switch stopper is screwed on the limit switch. The collector shoe 25 is mounted on the slider mounting seat 24, the second fixed blocks 21 are symmetrically mounted on the other side and the second spring adjustable connecting blocks 13 are symmetrically mounted on the other side. A stop block base 27 is mounted between the two second spring adjustable connecting blocks 13. A stop block 26 is mounted on the stop block base 27. The limit block 22 is mounted on the second fixed block 21. The second fixed block 21 is connected to the first fixed block 11 through a main shaft. The swing arm 20 may rotate around the main shaft.

As described above, the embodiments of the present disclosure are described in detail. There may be many variations as long as there is no substantial deviation from the inventive concept and effects of the present disclosure, which is apparent to those skilled in the in the art. Therefore, such variations are all intended to be included in the scope of protection of the present disclosure.

What is claimed is:

1. A two-series spring damping type current collector for subway vehicles, comprising:
an insulating back plate, wherein the insulating back plate is connected to one side of each of second tooth-shaped plates through a corresponding one of first tooth-shaped plates arranged at two lateral portions of the insulating back plate, and an other side of the each of the second tooth-shaped plates is connected to a mounting plate;
a first spring assembly arranged on one side of the mounting plate, wherein the first spring assembly comprises a rubber block and a tension steel spring, one end of the tension steel spring is connected to a first spring connecting piece, an other end of the tension steel spring is connected to a second spring connecting piece, the tension steel spring is internally provided with the rubber block in a shape of cylinder, a diameter of the rubber block is equal to a diameter of an inner cavity of the tension steel spring, a length of the rubber block is equal to a length of the tension steel spring in a pre-tightened state, the first spring connecting piece is connected to a first spring adjustable connecting block through a first shaft, the first spring adjustable connecting block is connected to one end of a first bolt, an other end of the first bolt is connected to the mounting plate through a first rubber gasket and a first screw cap the second spring connecting piece is connected to a second spring adjustable connecting block through a second shaft, the second spring adjustable connecting block is connected to one end of a second bolt, and an other end of the second bolt is connected to a swing arm through a second rubber gasket and a second screw cap; and
a swing arm assembly comprising the swing arm, a slider mounting seat and a collector shoe, wherein one end of the swing arm is connected to the mounting seat and the collector shoe, and an other end of the swing arm is connected to a second fixed block connected to a limit block; a stopper is connected to the mounting plate; a first fixed block is connected to the mounting plate, the first fixed block is rotationally connected to the second fixed block through a main shaft,
wherein a limit mounting seat is connected to the mounting plate; a limit switch is connected to the limit mounting seat; the limit switch is connected to a limit shaft; a lower part of the limit switch is connected to a limit switch stopper; and a stop block is connected to the swing arm.

2. The two-series spring damping type current collector for subway vehicles according to claim 1, wherein a second spring assembly is arranged on an other side of the mounting plate, wherein the second spring assembly is identical to the first spring assembly.

3. The two-series spring damping type current collector for subway vehicles according to claim 1, wherein the swing arm is capable of performing an arc movement along an end face of the first fixed block.

4. The two-series spring damping type current collector for subway vehicles according to claim 1, wherein the limit block is capable of being in contact with the stopper.

5. The two-series spring damping type current collector for subway vehicles according to claim 1, wherein the limit switch stopper is capable of being in contact with the stop block.

6. The two-series spring damping type current collector for subway vehicles according to claim 1, wherein an upward swing limit of the swing arm is determined by contact of the limit block with the stopper; and a downward swing limit of the swing arm is determined by contact of the limit switch stopper with the stop block.
